(19) United States
(12) Patent Application Publication
(10) Pub. No.: US 2026/0105404 A1
(43) Pub. Date: Apr. 16, 2026

(54) SYSTEMS AND METHODS FOR TRAINING WORKFORCE IN A FACILITY

(71) Applicant: Honeywell International Inc., Charlotte, NC (US)

(72) Inventors: Ankit Singh, Apex, NC (US); Srihari Narayanaiah, Bangalore (IN); Kartik Bollapalli, Bangalore (IN)

(21) Appl. No.: 18/916,780

(22) Filed: Oct. 16, 2024

(51) Int. Cl. G06Q 10/0631; G06F 9/451

(52) U.S. Cl. CPC G06Q 10/06398; G06Q 10/063118; G06Q 10/0639; G06Q 10/06393; G06Q 10/06395

(57) ABSTRACT

Various embodiments described herein relate to systems and methods for training workforce in a facility. In this regard, traceability events captured by workers in the facility is initially received. These traceability events are related to products that are handled in the facility. Using predefined rules, the traceability events are then validated. Upon validation, it is determined if each of the traceability events comprises an error. If at least one traceability event comprises the error, the error is compared with a threshold value. If the error exceeds the threshold value, a training recommendation for at least one of the workers is provided. Additionally, at least one training module is identified based on the training recommendation. Also, the at least one of the workers is prompted to undertake the at least one training module.

### TECHNICAL FIELD

The present disclosure relates generally to training workforces in a facility, and more particularly to systems and methods for providing appropriate recommendations and training content for selectively training workforce in the facility.

### BACKGROUND

Generally, facilities (such as a warehouse, a supply chain department, a distribution center, a sorting hub, a logistics center, and/or the like) related to material handling enable movement of goods or products between manufacturers and consumers. It is essential to monitor such movement of the goods at every stage in order to avoid likely damages to the goods or loss of the goods. To have a visibility on the movement of the goods, the facilities may often rely on messaging standards such as EPCIS (Electronic Product Code Information Services). In this regard, the facilities may capture the movement of the goods at every stage as events in EPCIS format which may correspond to, for instance, structured Extensible Markup Language (XML). It is to be noted that workers in the facilities are often expected to report these events using techniques such as barcode scanning, Radio Frequency Identification (RFID) scanning, Enterprise Resource Planning (ERP) systems, middleware integrations, and/or the like. In addition to usage of these techniques, the workers are also expected to manually provide certain information at every stage of the movement of the goods. Provided that hundreds or even thousands of goods move through these facilities, there are high chances that the workers may provide incorrect information while reporting these events. Also, at times, the workers may fail to accurately scale up to humungous flow of goods in order to provide correct information for each of the goods. There might be several reasons for such inaccuracies. For instance, some of the workers may be newly onboarded to report such events and they may lack sufficient knowledge to provide appropriate information related to the goods. In another instance, some of the workers may be part time workers in the facilities who may not be sufficiently trained to provide appropriate information related to the goods. With such reasons or constraints, some of the events reported for the movement of the goods may be inaccurate. This may ultimately result in poor handling of the goods in the facilities while also causing damages or even loss of some goods. Thus, overall handling of the goods becomes a challenging task in the facilities related to material handling.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 illustrates a schematic diagram showing an exemplary environment comprising multiple facilities, in accordance with one or more example embodiments described herein.

FIG. 2 illustrates a schematic diagram showing an implementation of a controller that may execute techniques in accordance with one or more example embodiments described herein.

FIG. 3 illustrates a schematic diagram showing an implementation of an exemplary training recommendation system, in accordance with one or more example embodiments described herein.

FIG. 4 illustrates a schematic diagram showing an exemplary block diagram associated with one or more functions of exemplary training recommendation system, in accordance with one or more example embodiments described herein.

FIGS. 5A-5D illustrate schematic diagrams showing exemplary user interfaces associated with an exemplary training recommendation system, in accordance with one or more example embodiments described herein.

FIG. 6 illustrates a flowchart showing a method described in accordance with one or more example embodiments described herein.

FIG. 7 illustrates a flowchart showing a method described in accordance with one or more example embodiments described herein.

FIG. 8 illustrates a flowchart showing a method described in accordance with one or more example embodiments described herein.

### SUMMARY

The details of some embodiments of the subject matter described in this specification are set forth in the accompanying drawings and the description below. Other features, aspects, and advantages of the subject matter will become apparent from the description, the drawings, and the claims.

In accordance with one or more example embodiments of the current disclosure, a method for training workforce in a facility is described herein. In this regard, the method comprises receiving one or more traceability events captured by one or more workers in the facility. The one or more traceability events are related to one or more products that are handled in the facility. Further, the method comprises validating each of the one or more traceability events using one or more predefined rules. Then, the method comprises determining if each of the one or more traceability events comprises an error based on the one or more predefined rules. Furthermore, the method comprises comparing the error with a threshold value if at least one traceability event comprises the error. Also, the method then comprises providing a training recommendation for at least one of the one or more workers if the error exceeds the threshold value. Based on the training recommendation, the method then comprises identifying at least one training module. Additionally, the method also comprises prompting the at least one of the one or more workers to undertake the at least one training module.

In accordance with another embodiment of the current disclosure, a system for training workforce in a facility is described herein. The system comprises a processor and a memory communicatively coupled to the processor, wherein the memory comprises one or more instructions which when executed by the processor, cause the processor to receive one or more traceability events captured by one or more workers in the facility. In this regard, the one or more traceability events are related to one or more products that are handled in the facility. Further, the processor is configured to validate each of the one or more traceability events using one or more predefined rules. Then, the processor is configured to determine if each of the one or more traceability events comprises an error based on the one or more predefined rules. Furthermore, the processor is configured to compare the error with a threshold value if at least one traceability event comprises the error. Also, the processor is configured to provide a training recommendation for at least one of the one or more workers if the error exceeds the threshold value. Based on the training recommendation, the processor is also configured to identify at least one training module. Additionally, the processor is configured to prompt the at least one of the one or more workers to undertake the at least one training module.

In accordance with yet another embodiment of the current disclosure, a non-transitory, computer-readable storage medium having instructions stored thereon and executable by one or more processors is described herein. In this regard, the instructions when executed by one or more processors cause the one or more processors to receive one or more traceability events captured by one or more workers in a facility. In this regard, the one or more traceability events are related to one or more products that are handled in the facility. Further, the one or more processors are configured to validate each of the one or more traceability events using one or more predefined rules. Then, the one or more processors are configured to determine if each of the one or more traceability events comprises an error based on the one or more predefined rules. Furthermore, the one or more processors are configured to compare the error with a threshold value if at least one traceability event comprises the error. Also, the one or more processors are configured to provide a training recommendation for at least one of the one or more workers if the error exceeds the threshold value. Based on the training recommendation, the one or more processors are also configured to identify at least one training module. Additionally, the one or more processors are configured to prompt the at least one of the one or more workers to undertake the at least one training module.

The above summary is provided merely for purposes of providing an overview of one or more exemplary embodiments described herein so as to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which are further explained in the following description and its accompanying drawings.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### DETAILED DESCRIPTION OF THE DRAWINGS

Reference will now be made in detail to embodiments, examples of which are illustrated in the accompanying drawings. In the following detailed description, numerous specific details are set forth in order to provide a thorough understanding of the various described example embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments. The term “or” is used herein in both the alternative and conjunctive sense, unless otherwise indicated. The terms “illustrative,” “example,” and “exemplary” are used to be examples with no indication of quality level. Like numbers refer to like elements throughout.

The phrases “in an embodiment,” “in one embodiment,” “according to one embodiment,” and the like generally mean that the particular feature, structure, or characteristic following the phrase can be included in at least one example embodiment of the present disclosure, and can be included in more than one example embodiment of the present disclosure (importantly, such phrases do not necessarily refer to the same example embodiment).

The word “exemplary” is used herein to mean “serving as an example, instance, or illustration.” Any implementation described herein as “exemplary” is not necessarily to be construed as preferred or advantageous over other implementations. If the specification states a component or feature “can,” “may,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature can be optionally included in some example embodiments, or it can be excluded.

At times, facilities related to material handling operations employ huge workforce to handle various goods moving through facilities. In this regard, the workforce may undertake various operations in the facilities to ensure smooth movement of the goods from one stage to another stage. It is to be noted that some of the goods may require appropriate environment to be maintained throughout its movement between manufacturer and customer while some other goods may require special equipment for handling. To handle the goods based on their requirements, it becomes necessary to keep a track of the goods that are moving through the facilities. Also, the facilities may be required to capture status of each and every good as several events to maintain a record of how each of the goods was handled. Such events are often captured by the workers handling respective goods as EPCIS (Electronic Product Code Information Services) events using technologies such as barcode scanning, Radio Frequency Identification (RFID) scanning, Enterprise Resource Planning (ERP) systems, middleware integrations, and/or the like. However, the workers are also expected to manually provide some information regarding the events. Provided that the workforce may include variety of workers with different skillsets and levels of experiences, there may be several errors that may occur at this point due to insufficient knowledge of certain workers. With such workers, some of the goods may be handled without complying to requirements while information provided for respective goods may be incorrect as well. For example, while scanning a barcode at a delivery hub, a worker may wrongly scan the barcode or scan an incorrect identifier on a good as a part of event reporting. In another example, a worker may incorrectly select a business step while reporting a corresponding event. Yet in another example, a worker may erroneously set a temperature required for shipping a good and report the same as an event. Lack of knowledge of some workers becomes one of a challenge to appropriately handle the goods in the facilities. This often results in poor performance of the facilities with regards to handling the goods and reporting correct events in the facilities. While this also impacts overall productivity of the facilities as well.

Thus, to address the above challenges, various examples of systems and methods described herein provide appropriate recommendations and training content (such as modules) for selectively training workforce in the facility. Initially, the system described herein receives one or more traceability events captured by one or more workers of the workforce in the facility. As it may be understood, the one or more workers capture the said traceability event(s) using techniques such as barcode scanning, Radio Frequency Identification (RFID) scanning, Enterprise Resource Planning (ERP) systems, middleware integrations, and/or the like. In this regard, the one or more workers also utilize several appropriate devices (such as handheld devices, computing devices, and/or the like) in the facility to capture the said traceability event(s). It is to be appreciated that at least some steps during the capturing of the traceability event(s) using such techniques may be automated as well. Additionally, as a part of capturing the one or more traceability events, the one or more workers also manually provide information related to the one or more products. This information may be provided as textual input(s) and/or audio input(s) by the one or more workers for instance, via the devices that are used to capture the said traceability event(s). It is to be noted that the one or more traceability events captured often relate to one or more products that are handled in the facility. More particularly, a traceability event for a product comprises data such as description of the product, relationship between the product with other product(s), business transaction(s) related to the product, details of transformation of the product, a stage at which the product is in during its movement between a manufacturer and an end consumer, identifier(s) associated with the product, operation(s) performed by a worker for handling that product, information provided by a worker for the product, and/or the like. Also, the one or more traceability events described herein may be, for instance, captured as EPCIS (Electronic Product Code Information Services) events and formatted in structured Extensible Markup Language (XML) format as well. Upon capturing the one or more traceability events, the devices that are used to capture the said traceability event(s) transmit the one or more traceability events over a network to the system.

Further, the system described herein validates each of the one or more traceability events using one or more predefined rules. At this point, the system considers the data in each of the one or more traceability events and then validates the data using the one or more predefined rules. For example, the system may validate whether an identifier such as a batch number in data of a traceability event for a product is correctly captured and formatted as expected by business requirements. In another example, the system may validate whether a stage at which a product is in during its movement is correctly captured or not. Yet in another example, the system may validate whether environmental conditions comply with required specifications for a product. It is also to be noted that the one or more predefined rules may be prioritized based on a context of operation in the facility as well. Based on the validation, the system then determines if each of the one or more traceability events comprises an error. Such a determination is based on the one or more predefined rules. For instance, if a batch number is incorrectly captured for a product, then the system may flag that corresponding traceability event has as an error. In another instance, if a stage at which a product is in during its movement is incorrect, then the system may flag that corresponding traceability event has as an error. Yet in another instance, if a temperature required for shipping a product is incorrectly maintained, then also the system may flag that corresponding traceability event has as an error. Also, the system assigns a category under which the error determined in the traceability event falls under as well. It is to be noted that such a category may be defined based at least on the operations in the facility.

Furthermore, the system compares the error with a threshold value in response to determining that at least one traceability event comprises the error. If the comparison of the error exceeds the threshold value, the system provides a training recommendation for at least one of the one or more workers. The training recommendation comprises a training outline which the system recommends for the at least one of the one or more workers based on the error. It is to be noted that the system also renders the training recommendation along with the determined error on a user interface. Based on the training recommendation, the system also identifies at least one training module that is to be used to train the at least one of the one or more workers. In this regard, the system prompts the at least one of the one or more workers to undertake the at least one training module. Also, the system described herein provides one or more notifications such as alerts, alarms, and/or the like in response to determining that at least one traceability event comprises the error. Additionally, the system also generates one or more corrective actions to address the error occurred along with the training recommendation as well. With this, the system described herein uses traceability events in the facility to build a comprehensive and relevant training plan for workforces in the facility. This helps the facility manage inefficiencies in handling products or packages due to lack of knowledge of certain workers. Also, this facilitates regular upskilling of the workforce in the facility thereby increasing overall productivity of the facility as well.

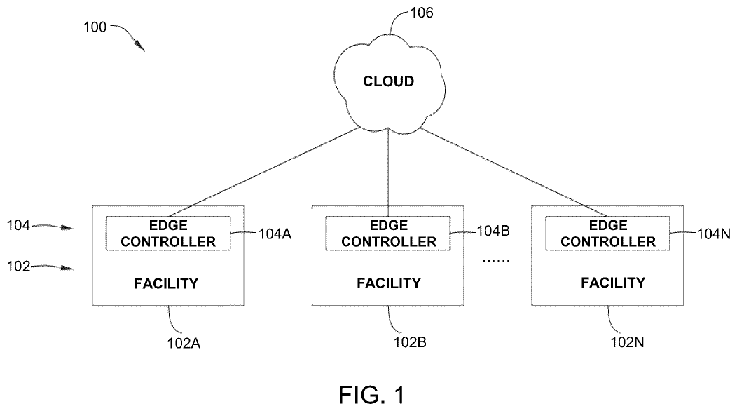

FIG. 1 illustrates a schematic diagram showing an exemplary environment comprising multiple facilities. According to various example embodiments described herein, an exemplary environment 100 comprises one or more facilities 102a, 102b, . . . 102n (collectively “facilities 102”). In some example embodiments, a facility of the one or more facilities 102a, 102b, . . . 102n may correspond to, for example, a building, a factory, an industry, an airport premises, a pharmaceutical industry, a transportation hub, a logistics environment, a sorting hub, a material handling environment, a warehouse, a supply chain department, a distribution center, an industrial plant, and/or the like which involves material handling operations. In some example embodiments, the one or more facilities 102a, 102b, . . . 102n in the illustrative environment 100 may be of same type. In some example embodiments, the one or more facilities 102a, 102b, . . . 102n in the illustrative environment 100 may be of different type. As it may be understood, in some example embodiments described herein, a facility of the one or more facilities 102a, 102b, . . . 102n often employs several workers or personnel to handle numerous goods or products or packages in the facility. In this regard, the facility may include several groups of workers to facilitate numerous operations associated with handling of the products in the facility. For example, certain set of workers may facilitate scanning operations when products to be shipped are first received at the facility while other set of workers may facilitate creating records for products that are recalled by the facility. At times, while performing such operations to handle the products, the workers are expected to use certain appropriate devices and provide appropriate information related to handled products as well. However, some of the workers may lack sufficient knowledge on performing the operations and handling the products in the facility. In such circumstances, the workers need to be skilled or trained enough to handle the operations and thereby handle the products efficiently. Additionally, at times, the workers need to upskill themselves as well. Per this aspect, the facilities 102 are required to provide appropriate training to their workforce.

In some example embodiments, a cloud 106 is operably coupled with one or more facilities 102a, 102b, . . . 102n, meaning that communication between the cloud 106 and one or more facilities 102a, 102b, . . . 102n is enabled. The cloud 106 may represent distributed computing resources, software, platform or infrastructure services which can enable data handling, data processing, data management, and/or analytical operations on the data exchanged & transacted in the facilities 102. In some example embodiments described herein, the cloud 106 represents a platform that comprises one or more services to manage training in the facilities 102. Per this aspect, the one or more services of the cloud 106 appropriately handle, process, and/or manage the data at the cloud 106 to provide appropriate recommendations and training content for selectively training workforce in the facility. In this regard, the data at the cloud 106 often corresponds to one or more traceability events captured by one or more workers of the workforce in the facility. This data may also comprise metadata and/or other relevant data associated with the facility as well. Also, the cloud 106 may include or generate models required to handle, process, and/or manage the data in order to provide recommendations and training content for workforce in a respective facility. In some example embodiments, the cloud 106 includes one or more servers that may be programmed to communicate with the one or more facilities 102a, 102b, . . . 102n and to exchange data as appropriate. The cloud 106 may be a single computer server or may include a plurality of computer servers. In some example embodiments, the cloud 106 may represent a hierarchal arrangement of two or more computer servers, where perhaps a lower-level computer server (or servers) processes the data, for example, while a higher-level computer server oversees operation of the lower-level computer server or servers.

Each of the facilities 102 may include a variety of different operations. For example, in a facility related to material handling, several products often flow through the facility as a part of movement of the products between manufacturer and end consumer. In this regard, there may be several operations at stages such as shipping, transportation, sorting, distribution, and/or the like. To have a visibility on the movement of the products through such stages, it becomes vital for the facility to keep a track of the products moving through the facility. In this regard, workforce in the facility often captures all relevant information related to the products moving through the facility as one or more traceability events. As it may be understood, the workforce that is, one or more workers in the facility often utilize techniques such as barcode scanning, Radio Frequency Identification (RFID) scanning, Enterprise Resource Planning (ERP) systems, middleware integrations, and/or the like to capture the one or more traceability events. Per this aspect, the one or more workers utilize several appropriate devices (such as handheld devices, computing devices, and/or the like) in the facility to capture the one or more traceability events. Additionally, the one or more workers also manually provide certain information related to the products as a part of capturing the one or more traceability events as well. In the example shown in FIG. 1, each of the one or more facilities 102a, 102b, . . . 102n includes a respective edge controller (alternatively, edge gateway) 104a, 104b, . . . 104n (collectively “edge controllers 104” or “edge gateways 104”). In some example embodiments, each of one or more edge controllers 104a, 104b, . . . 104n is configured to receive the data from the respective facilities 102. In some examples, the one or more edge controllers 104a, 104b, . . . 104n may operate as intermediary node to transact the data between the facilities 102 and/or the cloud 106. In this regard, the data includes one or more traceability events associated with the operations in the facilities 102. Additionally, the data also includes metadata and/or other relevant data associated with the facilities 102. In some examples, each of the one or more edge controllers 104a, 104b, . . . 104n is capable of receiving the data from disparate data sources e.g., but not limited to, in different data formats and/or using various data communication protocols, from the facilities 102. In this regard, each of the one or more edge controllers 104a, 104b, . . . 104n can receive & filter the data and translate the data into a common language and/or format (e.g. normalized data) for subsequent communication to the cloud 106. The common language and/or format may be compatible with and expected by the cloud 106.

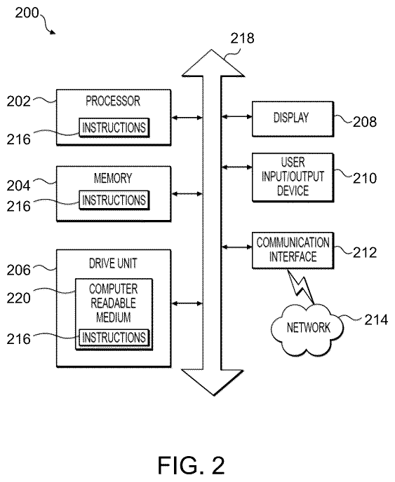

FIG. 2 illustrates a schematic diagram showing an implementation of a controller that may execute techniques in accordance with one or more example embodiments described herein. In one or more example embodiments, controller 200 described herein may include a set of instructions that can be executed to cause the controller 200 to perform any one or more of the methods or computer-based functions disclosed herein. The controller 200 may operate as a standalone device or may be connected, e.g., using a network, to other computer systems or peripheral devices.

In a networked deployment, the controller 200 may operate in the capacity of a server or as a client in a server-client user network environment, or as a peer computer system in a peer-to-peer (or distributed) network environment. The controller 200 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 200 can be implemented using electronic devices that provide voice, video, or data communication. Further, while the controller 200 is illustrated as a single system, the term “system” shall also be taken to include any collection of systems or sub-systems that individually or jointly execute a set, or multiple sets, of instructions to perform one or more computer functions.

As illustrated in FIG. 2, the controller 200 may include a processor 202, e.g., a central processing unit (CPU), a graphics processing unit (GPU), or both. The processor 202 may be a component in a variety of systems. For example, the processor 202 may be part of a standard computer. The processor 202 may be one or more general processors, digital signal processors, application specific integrated circuits, field programmable gate arrays, servers, networks, digital circuits, analog circuits, combinations thereof, or other now known or later developed devices for analyzing and processing data. The processor 202 may implement a software program, such as code generated manually (i.e., programmed).

The controller 200 may include a memory 204 that can communicate via a bus 218. The memory 204 may be a main memory, a static memory, or a dynamic memory. The memory 204 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 204 includes a cache or random-access memory for the processor 202. In alternative implementations, the memory 204 is separate from the processor 202, such as a cache memory of a processor, the system memory, or other memory. The memory 204 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 204 is operable to store instructions executable by the processor 202. The functions, acts or tasks illustrated in the figures or described herein may be performed by the processor 202 executing the instructions stored in the memory 204. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As shown, the controller 200 may further include a display 208, such as a liquid crystal display (LCD), an organic light emitting diode (OLED), a flat panel display, a solid-state display, a cathode ray tube (CRT), a projector, a printer or other now known or later developed display device for outputting determined information. The display 208 may act as an interface for the user to see the functioning of the processor 202, or specifically as an interface with the software stored in the memory 204 or in the drive unit 206. Additionally or alternatively, the controller 200 may include an input/output device 210 configured to allow a user to interact with any of the components of controller 200. The input/output device 210 may be a number pad, a keyboard, or a cursor control device, such as a mouse, or a joystick, touch screen display, remote control, or any other device operative to interact with the controller 200. The controller 200 may also or alternatively include drive unit 206 implemented as a disk or optical drive. The drive unit 206 may include a computer-readable medium 220 in which one or more sets of instructions 216, e.g. software, can be embedded. Further, the instructions 216 may embody one or more of the methods or logic as described herein. The instructions 216 may reside completely or partially within the memory 204 and/or within the processor 202 during execution by the controller 200. The memory 204 and the processor 202 also may include computer-readable media as discussed above.

In some systems, a computer-readable medium 220 includes instructions 216 or receives and executes instructions 216 responsive to a propagated signal so that a device connected to a network 214 can communicate voice, video, audio, images, or any other data over the network 214. Further, the instructions 216 may be transmitted or received over the network 214 via a communication port or interface 212, and/or using a bus 218. The communication port or interface 212 may be a part of the processor 202 or may be a separate component. The communication port or interface 212 may be created in software or may be a physical connection in hardware. The communication port or interface 212 may be configured to connect with a network 214, external media, the display 208, or any other components in controller 200, or combinations thereof. The connection with the network 214 may be a physical connection, such as a wired Ethernet connection or may be established wirelessly as discussed below. Likewise, the additional connections with other components of the controller 200 may be physical connections or may be established wirelessly. The network 214 may alternatively be directly connected to a bus 218.

While the computer-readable medium 220 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 220 may be non-transitory, and may be tangible. The computer-readable medium 220 can include a solid-state memory such as a memory card or other package that houses one or more non-volatile read-only memories. The computer-readable medium 220 can be a random-access memory or other volatile re-writable memory. Additionally or alternatively, the computer-readable medium 220 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The controller 200 may be connected to a network 214. The network 214 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 214 may include wide area networks (WAN), such as the Internet, local area networks (LAN), campus area networks, metropolitan area networks, a direct connection such as through a Universal Serial Bus (USB) port, or any other networks that may allow for data communication. The network 214 may be configured to couple one computing device to another computing device to enable communication of data between the devices. The network 214 may generally be enabled to employ any form of machine-readable media for communicating information from one device to another. The network 214 may include communication methods by which information may travel between computing devices. The network 214 may be divided into sub-networks. The sub-networks may allow access to all of the other components connected thereto or the sub-networks may restrict access between the components. The network 214 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof. It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

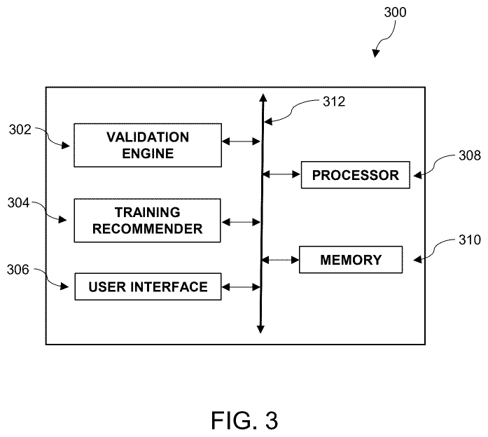

FIG. 3 illustrates a schematic diagram showing an implementation of an exemplary training recommendation system, in accordance with one or more example embodiments described herein. In one or more example embodiments, the training recommendation system 300 described herein provides relevant recommendations and training content such as training modules for selectively training workforce in a facility (for instance, one or more facilities 102a, 102b, . . . 102n as described in FIG. 1 of the current disclosure). To provide such recommendations and training content, the training recommendation system 300 considers one or more traceability events related to one or more products that are handled in the facility. The one or more traceability events may be, but not limited to scanning of product(s) that are received at the facility, creating appropriate environmental conditions for product(s) that are handled by the facility, handling recalled product(s) at the facility, updating a stage at which product(s) is in at the facility, scanning of product(s) that are to be shipped from the facility, and/or the like. Such traceability events are often captured by one or more workers of the workforce in the facility using one or more devices. The training recommendation system 300 receives such traceability events from the one or more devices. Then, the one or more traceability events are validated by the training recommendation system 300. In this regard, the training recommendation system 300 utilizes one or more predefined rules to validate the one or more traceability events. Upon validation of the one or more traceability events, the training recommendation system 300 determines if each of the one or more traceability events comprises an error. This determination of the error is also based on the one or more predefined rules used for validation of the one or more traceability events. Also, the training recommendation system 300 assigns a category for the determined error as well. Further, the training recommendation system 300 compares the error with a threshold value if at least one traceability event comprises the error. If the comparison of the error exceeds the threshold value, the training recommendation system 300 provides a training recommendation for at least one of the one or more workers. In this regard, the training recommendation comprises a training outline which the training recommendation system 300 recommends for the at least one of the one or more workers. Based on the training recommendation, the training recommendation system 300 identifies a choice of training module(s) that is to be used to train the at least one of the one or more workers. Also, the training recommendation system 300 prompts the at least one of the one or more workers to undertake the training module(s). With this, the training recommendation system 300 constructs a comprehensive and relevant training plan for the workforce in the facility.

In some example embodiments, the training recommendation system 300 may correspond to a server system (e.g., a server device) that facilitates a data analytics platform between one or more computing devices, one or more data sources, and/or one or more facilities. In some example embodiments, the training recommendation system 300 is a device with one or more processors and a memory. Also, in some example embodiments, the training recommendation system 300 is implementable via the cloud 106. In this regard, in some example embodiments, the cloud 106 may comprise one or more relevant services to provide relevant recommendations and training content. The training recommendation system 300 is implementable in one or more facilities related to one or more technologies, for example, but not limited to, enterprise technologies, connected building technologies, industrial technologies, Internet of Things (IoT) technologies, data analytics technologies, digital transformation technologies, cloud computing technologies, cloud database technologies, server technologies, network technologies, private enterprise network technologies, wireless communication technologies, machine learning technologies, artificial intelligence technologies, digital processing technologies, electronic device technologies, computer technologies, supply chain analytics technologies, aircraft technologies, industrial technologies, cybersecurity technologies, navigation technologies, asset visualization technologies, oil and gas technologies, petrochemical technologies, refinery technologies, life science technologies, process plant technologies, procurement technologies, and/or one or more other technologies.

In some example embodiments, the training recommendation system 300 comprises one or more components such as, a validation engine 302, a training recommender 304, and/or a user interface 306. Additionally, in one or more example embodiments, the training recommendation system 300 comprises a processor 308 and/or a memory 310. In one or more example embodiments, one or more components of the training recommendation system 300 may be communicatively coupled to the processor 308 and/or a memory 310 via a bus 312. In certain example embodiments, one or more aspects of the training recommendation system 300 (and/or other systems, apparatuses and/or processes disclosed herein) constitute executable instructions embodied within a computer-readable storage medium (e.g., the memory 310). For instance, in an example embodiment, the memory 310 stores computer executable component and/or executable instructions (e.g., program instructions). Furthermore, the processor 308 facilitates execution of the computer executable components and/or the executable instructions (e.g., the program instructions). In an example embodiment, the processor 308 is configured to execute instructions stored in the memory 310 or otherwise accessible to the processor 308.

The processor 308 is a hardware entity (e.g., physically embodied in circuitry) capable of performing operations according to one or more embodiments of the disclosure. Alternatively, in an example embodiment where the processor 308 is embodied as an executor of software instructions, the software instructions configure the processor 308 to perform one or more algorithms and/or operations described herein in response to the software instructions being executed. In an example embodiment, the processor 308 is a single core processor, a multi-core processor, multiple processors internal to the training recommendation system 300, a remote processor (e.g., a processor implemented on a server), and/or a virtual machine. In certain example embodiments, the processor 308 is in communication with the memory 310, the validation engine 302, the training recommender 304, and/or the user interface 306 via the bus 312 to, for example, facilitate transmission of data between the processor 308, the memory 310, the validation engine 302, the training recommender 304, and/or the user interface 306. In some example embodiments, the processor 308 may be embodied in a number of different ways and, in certain example embodiments, includes one or more processing devices configured to perform independently. Additionally or alternatively, in one or more example embodiments, the processor 308 includes one or more processors configured in tandem via the bus 312 to enable independent execution of instructions, pipelining of data, and/or multi-thread execution of instructions.

The memory 310 is non-transitory and includes, for example, one or more volatile memories and/or one or more non-volatile memories. In other words, in one or more example embodiments, the memory 310 is an electronic storage device (e.g., a computer-readable storage medium). The memory 310 is configured to store information, data, content, one or more applications, one or more instructions, or the like, to enable the training recommendation system 300 to carry out various functions in accordance with one or more embodiments disclosed herein. In accordance with some example embodiments described herein, the memory 310 may correspond to an internal or external memory of the training recommendation system 300. In some examples, the memory 310 may correspond to a database communicatively coupled to the training recommendation system 300. As used herein in this disclosure, the term “component,” “system,” and the like, is a computer-related entity. For instance, “a component,” “a system,” and the like disclosed herein is either hardware, software, or a combination of hardware and software. As an example, a component is, but is not limited to, a process executed on a processor, a processor circuitry, an executable component, a thread of instructions, a program, and/or a computer entity.

In one or more example embodiments, the validation engine 302 of the training recommendation system 300 initially receives the one or more traceability events. The one or more traceability events received at the validation engine 302 of the training recommendation system 300 relate to the one or more products that are handled in the facility. That is, to facilitate movement of the one or more products between a manufacturer and an end customer, the facility undertakes various material handling operations (or supply chain operations). More particularly, the one or more workers perform numerous material handling operations at different stages during movement of the one or more products between the manufacturer and the end customer. In this regard, the stages may be, but not limited to picking, packaging, placing, storing, sorting, shipping, distribution, transportation, delivery, and/or the like while the material handling operations may correspond to scanning appropriate identifier(s) associated with product(s), picking product(s), placing product(s), creation of records for product(s), setting environmental conditions for product(s), loading product(s) as appropriate, logging errors noticed with respect to product(s), segregating recalled product(s), reporting a stage at which product(s) is in during its movement, providing appropriate information related to product(s), and/or the like. As it may be understood, the facility often keeps a track of the one or more products that are handled at the facility along with the operations that are undertaken by the one or more workers for handling the said one or more products. Such track of the one or more products that are handled at the facility along with the operations that are undertaken by the one or more workers corresponds to the one or more traceability events. Said alternatively, details of the one or more products handled, and corresponding operations undertaken at respective stages for the one or more products are captured as one or more events. In this regard, a traceability event for a product comprises data such as description of the product, relationship between the product with other product(s), business transaction(s) related to the product, details of transformation of the product, a stage at which the product is in during its movement between a manufacturer and an end consumer, identifier(s) associated with the product, operation(s) performed by a worker for handling that product, information provided by a worker for the product, and/or the like. It is to be appreciated that the one or more traceability events provide visibility (what, where, why, when) associated with the movement of the products through the facility.

The said traceability event(s) are often captured by the one or more workers of the workforce in the facility. To capture the one or more traceability events, the one or more workers make use of at least one device of several devices in the facility as appropriate. In this regard, the devices may correspond to handheld devices, computing devices, and/or the like. It is to be noted that the devices may be based on techniques such as barcode scanning, Radio Frequency Identification (RFID) scanning, Enterprise Resource Planning (ERP) systems, middleware integrations, and/or the like. That is, using such techniques the devices facilitate the one or more workers to capture the traceability event(s) in the facility. For example, a worker may utilize a handheld device with RFID scanning capability to scan an RFID tag on a product that is to be shipped from the facility. With this, scanning operation undertaken by the worker is captured along with a stage of movement of the product as ‘to be shipped’ by the handheld device. In another example, a worker may scan a quick response (QR) code using a computing device with barcode scanning technique to create a record of a recalled product at the facility along with details such as batch number of the recalled product. With this, scanning operation undertaken by the worker is captured along with the batch number and a stage of movement of the product as ‘recalled at the facility’ by the computing device. It is to be appreciated that at least some steps involved during the capturing of the traceability event(s) using such techniques may be automated as well. In addition to usage of such techniques, the one or more workers are also expected to manually provide at least some information related to products handled by them as a part of capturing the one or more traceability events. The one or more workers provide such information via the at least one device in the facility. In this regard, the information may be provided as textual input(s) and/or audio input(s) by the one or more workers via the at least one device. For example, a worker may be expected to manually provide a business step after scanning a product received at the facility. In another example, a worker may be required to report environmental conditions maintained for a product that is to be shipped from the facility and this may be manually provided by the worker. Based at least on the above, the one or more workers capture the one or more traceability events. Further, it is to be noted that the devices in the facility are communicatively coupled to the training recommendation system 300. So, as and when the one or more workers capture the one or more traceability events say, using the at least one device, the one or more traceability events are transmitted to the training recommendation system 300 (that is, to the validation engine 302) by the at least one device (alternatively, the one or more traceability events are received at the training recommendation system 300 from the at least one device).

In one or more example embodiments, the validation engine 302 of the training recommendation system 300 then validates each of the one or more traceability events using the one or more predefined rules. To validate each of the one or more traceability events against the one or more predefined rules, the validation engine 302 considers the data in each of the one or more traceability events. The one or more predefined rules in the validation engine 302 comprise one or more instructions and/or one or more data requirements which the said traceability event(s) should satisfy. For example, a data requirement may correspond to presence of a batch number, a lot number, and a timestamp in a traceability event for a product that is to be shipped. In another example, an instruction may correspond to presence of reporting of a business step in a traceability event for a product that is recalled at the facility. Also, the validation engine 302 prioritizes the one or more predefined rules based on an operation related to the one or more products while validating each of the said traceability event(s). For instance, if a product is in a shipment section of the facility, the validation engine 302 selects and prioritizes at least one rule of the one or more predefined rules based on operation(s) (such as scanning, placing, and/or the like) related to shipment while validating corresponding traceability event. In another instance, if another product is in a recall section of the facility, the validation engine 302 selects and prioritizes at least one rule of the one or more predefined rules based on operation(s) (such as scanning, business step selection, and/or the like) related to recalling while validating corresponding traceability event. Yet in another instance, if yet another product is to be packed, the validation engine 302 selects and prioritizes at least one rule of the one or more predefined rules based on operation(s) (such as scanning, reporting of environment conditions and type of packaging material used, and/or the like) related to packaging while validating corresponding traceability event. It is to be appreciated that the validation engine 302 described herein dynamically selects and prioritizes at least one rule of the one or more predefined rules based on operation(s) related to handling the one or more products. It is to be noted that the one or more predefined rules may be defined by personnel associated with the facility. In this regard, the personnel may correspond to subject matter experts and/or technical specialists associated with the facility. Also, it is to be noted that the one or more predefined rules in the validation engine 302 may be updated at regular intervals of time as well.

Further, the validation engine 302 performs a check for the data in each of the one or more traceability events using the prioritized one or more predefined rules. In this regard, the validation engine 302 checks the data in each of the one or more traceability events considering one or more instructions and/or one or more data requirements in corresponding selected and prioritized rule(s). For example, the validation engine 302 checks if data in a traceability event for a product that is to be shipped from the facility comprises a batch number, a lot number, and a timestamp. In another example, the validation engine 302 checks if data in a traceability event for a product that is recalled at the facility comprises reporting of a business step along with a batch number and a timestamp. Also, in another example, the validation engine 302 checks if an identifier such as a batch number in data of a traceability event for a product is correctly captured and formatted as expected by business requirements. Further, in another example, the validation engine 302 checks if a stage at which a product is in during its movement is correctly captured or not in a traceability event. Yet in another example, the validation engine 302 checks if environmental conditions captured in a traceability event comply with required specifications for a product. Based on the foregoing, the validation engine 302 validates the said traceability event(s) received at the validation engine 302 from the appropriate devices in the facility.

Then, in one or more example embodiments, the validation engine 302 determines if each of the one or more traceability events comprises an error. This determination is based on the validation of the one or more traceability events. That is, based on performing the check for the data in each of the one or more traceability events, the validation engine 302 using the same predefined rules determines if each of the one or more traceability events comprises the error. In this regard, the validation engine 302 determines whether each of the one or more traceability events satisfy or do not satisfy the one or more predefined rules. For this, the validation engine 302 considers the data in each traceability event of the one or more traceability events. Per this aspect, the validation engine 302 verifies if the data in a traceability event meets one or more specifications as set forth in one or more instructions and/or one or more data requirements in corresponding rule(s) for the said traceability event. If the data in the said traceability event does not meet or fails to meet one or more specifications as forth in corresponding rule(s) for the said traceability event, then the validation engine 302 determines that the said traceability event comprises the error. For example, if a batch number is incorrectly captured for a product, then the validation engine 302 may flag upon verification that corresponding traceability event has as an error. In another instance, if a stage at which a product is in during its movement is incorrect, then the validation engine 302 may flag upon verification that corresponding traceability event has as an error. Yet in another instance, if a temperature required for shipping a product is incorrectly maintained, then also the validation engine 302 may flag upon verification that corresponding traceability event has as an error. The validation engine 302 performs such verification for each of the one or more traceability events to flag those traceability event(s) which comprise the error. Also, the validation engine 302 assigns a category for the error determined in respective traceability event. And it is to be noted that this assignment is based on an operation related to the one or more products. For example, if determined error corresponds to missing business step in data of a traceability event, then the validation engine 302 assigns a category of ‘Invalid Business Step’ to the determined error. In another example, if determined error corresponds to absence of lot number in data of a traceability event, then the validation engine 302 assigns a category of ‘Missing Master Data’ to the determined error. Yet in another example, if determined error corresponds to mismatch in environment conditions that is maintained for a product, then the validation engine 302 assigns a category of ‘Regulatory Non-Compliance’ to the determined error. It is to be noted that the validation engine 302 also renders the error determined for respective traceability event(s) via the user interface 306 as well.

Also, in one or more example embodiments described herein, the validation engine 302 provides one or more notifications to the at least one of the one or more workers in response to determining that the at least one traceability event comprises the error. In this regard, the one or more notifications may correspond to an alarm and/or an alert. Additionally, in one or more example embodiments, the validation engine 302 also generates one or more corrective actions to address the error in response to determining that the at least one traceability event comprises the error. It is to be appreciated that the validation engine 302 facilitates rendering of the one or more corrective actions via the user interface 306 as well. The one or more corrective actions generated herein facilitate respective worker(s) to correct the error and/or take actions for the error that is determined in a corresponding traceability event. The user interface 306 may correspond to a graphical user interface (GUI), a human computer interface (HCI), and/or the like.

Further, in one or more example embodiments, the validation engine 302 compares the error with the threshold value in response to determining that at least one traceability event comprises the error. That is, the validation engine 302 compares the error determined for respective traceability event(s) with its corresponding threshold value. The threshold value may be defined by personnel associated with the facility. In this regard, the personnel may correspond to subject matter experts and/or technical specialists associated with the facility. Also, it is to be noted that the threshold value in the validation engine 302 may be updated at regular intervals of time as well. Additionally, it is to be noted that the threshold value is defined considering the category of the error as well. For instance, ‘Regulatory Non-Compliance’ category of errors may have a first threshold value while ‘Missing Master Data’ category of errors may have a second threshold value. In view of this, an error determined under ‘Regulatory Non-Compliance’ category may be compared with the first threshold value while another error determined under ‘Missing Master Data’ category may be compared with the second threshold value. That is, the validation engine 302 considers a particular threshold value for comparing error(s) determined under that particular category. Further, in one or more example embodiments described herein, if the comparison of the error exceeds the threshold value, the training recommender 304 provides a training recommendation for at least one of the one or more workers. Also, the training recommender 304 identifies a gap in training for worker(s) or lack of proficiency in skills of worker(s) considering error(s) determined in a traceability event. The training recommendation described herein comprises a training outline which the training recommender 304 recommends for the at least one of the one or more workers based on the error. In this regard, the training recommendation comprises a training issue and a training specification based on the error in a corresponding traceability event. The training issue often indicates a gap in training for worker(s) or lack of proficiency in skills of worker(s) while the training specification often indicates details of training that is to be undertaken by worker(s) to bridge the gap or upskill. It is also to be noted that the training recommender 304 facilitates rendering of the training recommendation via the user interface 306 as well.

Also, in one or more example embodiments, the training recommender 304 identifies at least one training module that is to be used to train the at least one of the one or more workers. The training recommender 304 identifies the at least one training module considering the training recommendation. In some examples, the training recommender 304 may include the at least one training module. While in some examples, the training recommender 304 may fetch the at least one training module from an external database communicatively coupled with the training recommendation system 300. The identified at least one training module facilitates in bridging the gap in training for worker(s) and upskills worker(s) as well. It is to be appreciated that the at least one training module comprises content based at least on the training specification in the training recommendation. In this regard, the content in the at least one training module may be included as text, audio, video, and/or the like. Additionally, in one or more example embodiments described herein, the training recommender 304 prompts the at least one of the one or more workers to undertake the at least one training module. The prompts may correspond to audio prompts and/or visual prompts. With this, the training recommendation system 300 described herein uses traceability events in the facility to build a comprehensive and relevant training plan for workforces in the facility. This helps the facility manage inefficiencies in handling products or packages due to lack of knowledge of certain workers. Also, this facilitates regular upskilling of the workforce in the facility thereby increasing overall productivity of the facility as well.

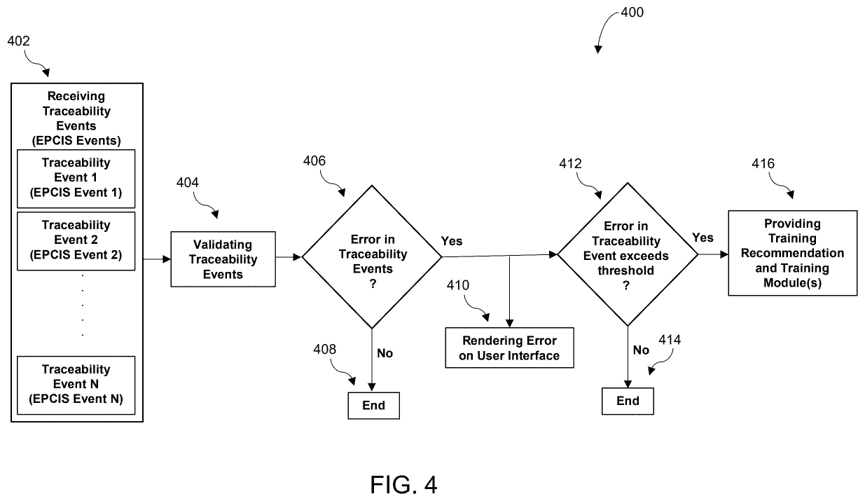

FIG. 4 illustrates a schematic diagram showing an exemplary block diagram associated with one or more functions of exemplary training recommendation system, in accordance with one or more example embodiments described herein. In this regard, the block diagram 400 described herein illustrates a flow of the one or more functions performed by the training recommendation system 300 described in accordance with FIG. 3 of the current disclosure. In some example embodiments, the block diagram 400 may correspond to an example implementation of the training recommendation system 300. At block 402, the validation engine 302 described herein receives one or more traceability events captured by one or more workers in the facility as described in FIG. 3 of the current disclosure. Per this aspect, the one or more traceability events described at block 402 specifically correspond to one or more EPCIS (Electronic Product Code Information Services) events. That is, a facility related to material handling operations often relies on EPCIS messaging standard to receive the one or more traceability events as one or more EPCIS events at the training recommendation system 300. In this regard, the facility maintains one or more EPCIS payloads in the validation engine 302 for one or more products that are handled at the facility. So, as and when a worker captures a traceability event for a product using at least one device at the facility (in a manner as described in FIG. 3 of the current disclosure), the traceability event gets formatted as an EPCIS event. That is, data in the traceability event may be formatted in structured Extensible Markup Language (XML). The at least one device then transmits this EPCIS event indicative of the said traceability event to the validation engine 302. Then, content in a respective EPCIS payload for the said product in the validation engine 302 also gets updated with the data as in the EPCIS event. Per this aspect, content in a respective EPCIS payload may get updated with the data that is formatted in structured XML. At block 404, the validation engine 302 validates each of the one or more traceability events using one or more predefined rules as described in FIG. 3 of the current disclosure. In this regard, the one or more EPCIS events are specifically validated by the validation engine 302 at block 404 using the one or more predefined rules. That is, the validation engine 302 considers data in each of the one or more EPCIS events and validates the data using the one or more predefined rules. Per this aspect, the validation engine 302 considers the data in respective EPCIS payloads, prioritizes the one or more predefined rules, and checks the data considering the one or more prioritized predefined rules in a manner as described in FIG. 3 of the current disclosure.

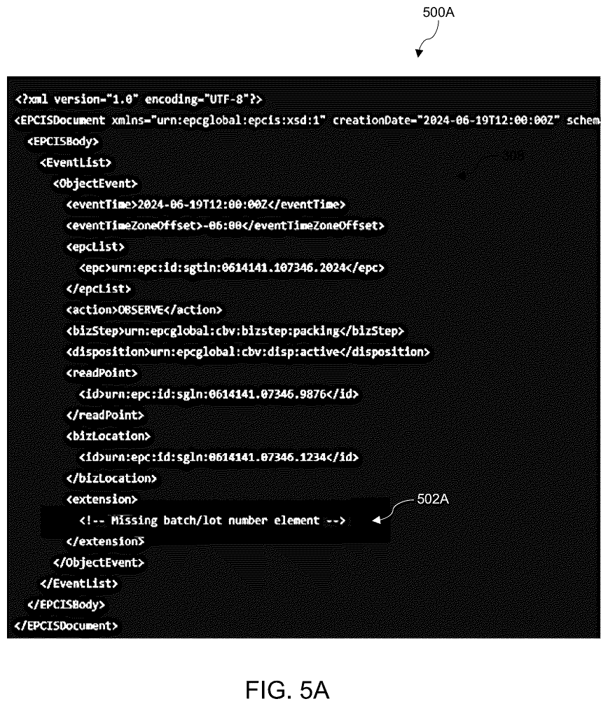

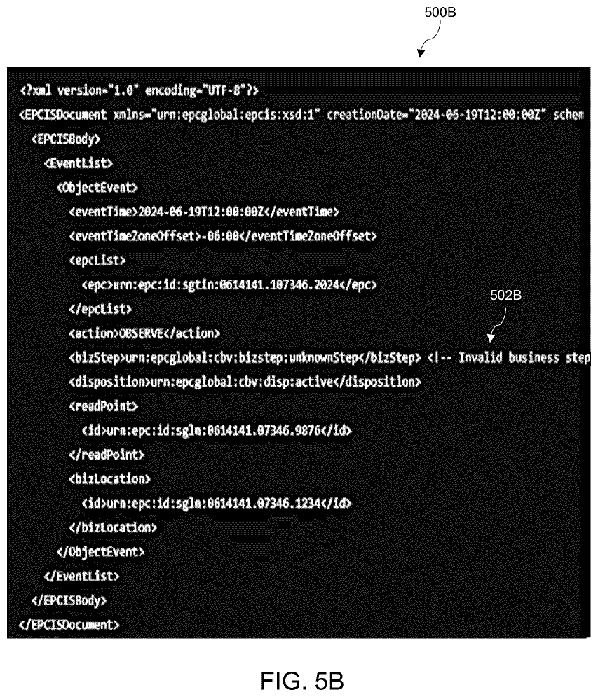

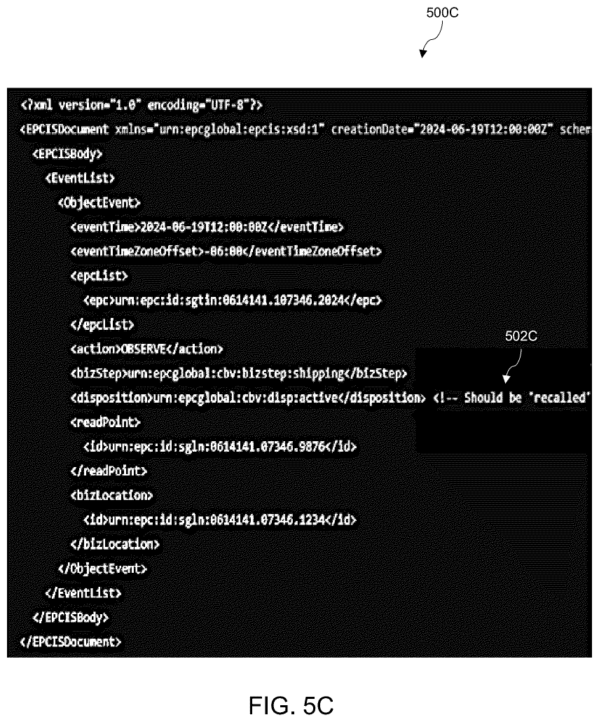

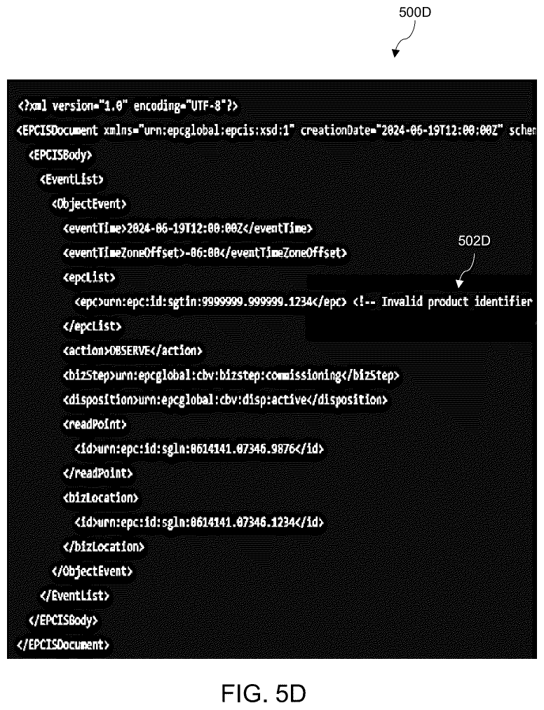

Further, at block 406, the validation engine 302 determines if each of the one or more traceability events comprises an error as described in FIG. 3 of the current disclosure. That is, at block 406, the validation engine 302 determines if each of the one or more EPCIS events comprises an error. This determination is based on the one or more predefined rules as well. In this regard, the data in respective EPCIS payloads is verified considering the one or more predefined rules in a manner as described in FIG. 3 of the current disclosure. If the validation engine 302 determines that at least one traceability event does not comprise the error, then the flow ends at block 408. If the validation engine 302 determines that at least one traceability event comprises the error, then the flow proceeds to block 412. Additionally, the validation engine 302 also facilitates rendering of the determined error via the user interface 306 as stated at block 410. Also, some example user interfaces that render errors are described in more details in accordance with FIGS. 5A-5D of the current disclosure.

At block 412, the validation engine 302 initially assigns a category for the error determined in respective EPCIS event in a manner as described in FIG. 3 of the current disclosure. Then, the validation engine 302 compares the error with a threshold value at block 412 as described in FIG. 3 of the current disclosure. In this regard, the error determined in a respective EPCIS event is compared with the threshold value in a manner as described in FIG. 3 of the current disclosure. If the comparison of the error does not exceed the threshold value, then the flow ends at block 414. If the comparison of the error exceeds the threshold value, then the flow proceeds to block 416. At block 416, the training recommender 304 provides a training recommendation for at least one of the one or more workers as described in FIG. 3 of the current disclosure. The training recommendation comprises a training issue and a training specification based on the error in a respective EPCIS event. The training issue indicates a gap in training for worker(s) or lack of proficiency in skills of worker(s) while the training specification indicates details of training that is to be undertaken by worker(s) to bridge the gap or upskill as described in FIG. 3 of the current disclosure. For example, if an error corresponds to a miss in batch/lot number in an EPCIS event, then a training recommendation may comprise a training issue as ‘Employees may not be adequately trained on the importance of batch/lot numbers and their critical role in traceability and compliance’ while a training specification may comprise ‘Training should cover the specific data elements required for EPCIS events and the implications of missing information’. In another example, if an error corresponds to an invalid business step in an EPCIS event, then a training recommendation may comprise a training issue as ‘Workers may not fully understand the defined business steps and how to correctly apply them in EPCIS documentation’ while a training specification may comprise ‘Training should include detailed explanations of each business step, proper usage, and common scenarios to avoid using invalid or unrecognized steps’. Further, in another example, if an error corresponds to improper handling of recalled products determined based on an EPCIS event, then a training recommendation may comprise a training issue as ‘Staff might not be aware of the correct procedures for handling and documenting recalled products’ while a training specification may comprise ‘Training should emphasize the correct use of dispositions, especially for critical situations like recalls, and the steps to take when a recall is necessary’. Also, in another example, if an error corresponds to an invalid product identifier in an EPCIS event, then a training recommendation may comprise a training issue as ‘Employees might not be familiar with the correct format and validation of product identifiers’ while a training specification may comprise ‘Training should include information on how to correctly format and validate EPC codes, and how to check for registration and accuracy’. Yet in another example, if an error corresponds to missing, incorrect, or incomplete data in an EPCIS event indicative of lack of attention to detail, then a training recommendation may comprise a training issue as ‘Employees may not be trained to carefully review and verify the data they enter’ while a training specification may comprise ‘Training should include best practices for data verification, emphasizing the importance of accuracy and attention to detail’. It is to be appreciated that the training recommendation may also be rendered via the user interface 306 as well at block 416. Also, at block 416, the training recommender 304 identifies at least one training module based on the training recommendation. The at least one training module corresponds to that module(s) which at least one of the one or more workers is required to undertake in order to bridge the gap and/or to upskill.

FIGS. 5A-5D illustrate schematic diagrams showing exemplary user interfaces associated with an exemplary training recommendation system, in accordance with one or more example embodiments described herein. In one or more example embodiments described herein, the user interfaces 500A-500D correspond to those interfaces that are renderable via a display of at least one device (as described in accordance with FIG. 3 of the current disclosure) in a facility. A user interface of the user interfaces 500A-500D may correspond to a graphical user interface (GUI), a human computer interface (HCI), and/or the like same as the user interface 306 described in accordance with FIG. 3 of the current disclosure. As described in FIG. 4 of the current disclosure, the validation engine 302 determines if the one or more EPCIS events comprises the error. That is, the validation engine 302 verifies data in respective EPCIS payloads considering the one or more predefined rules in a manner as described in FIG. 3 of the current disclosure. In case the validation engine 302 determines that at least one EPCIS event comprises the error, the validation engine 302 facilitates rendering of the error. For example, FIG. 5A illustrates a user interface 500A rendering data in an EPCIS payload of an EPCIS event which includes an error 502A. Initially, the validation engine 302 verifies the data in the EPCIS payload considering the one or more predefined rules in a manner as described in FIG. 3 of the current disclosure. Upon verifying that the data in the EPCIS event does not have a batch number, the validation engine 302 determines that the EPCIS event comprises error. In this regard, the data in the EPCIS payload of the EPCIS event along with the error 502A which corresponds to ‘Missing batch/lot number element’ is rendered on the user interface 500A as illustrated in FIG. 5A. In another example, FIG. 5B illustrates a user interface 500B rendering data in an EPCIS payload of an EPCIS event which includes an error 502B. Initially, the validation engine 302 verifies the data in the EPCIS payload considering the one or more predefined rules in a manner as described in FIG. 3 of the current disclosure. Upon verifying that the data in the EPCIS event has a business step which is an out of sequence or wrong step in material handling operations, the validation engine 302 determines that the EPCIS event comprises error. In this regard, the data in the EPCIS payload of the EPCIS event along with the error 502B which corresponds to ‘Invalid business step’ is rendered on the user interface 500B as illustrated in FIG. 5B. Further, in another example, FIG. 5C illustrates a user interface 500C rendering data in an EPCIS payload of an EPCIS event which includes an error 502C. Initially, the validation engine 302 verifies the data in the EPCIS payload considering the one or more predefined rules in a manner as described in FIG. 3 of the current disclosure. Upon verifying that the data in the EPCIS event has a disposition marked as “active” instead of “recalled” for a recalled product, the validation engine 302 determines that the EPCIS event comprises error. In this regard, the data in the EPCIS payload of the EPCIS event along with the error 502C which corresponds to ‘Should be recalled’ is rendered on the user interface 500C as illustrated in FIG. 5C. Yet in another example, FIG. 5D illustrates a user interface 500D rendering data in an EPCIS payload of an EPCIS event which includes an error 502D. Initially, the validation engine 302 verifies the data in the EPCIS payload considering the one or more predefined rules in a manner as described in FIG. 3 of the current disclosure. Upon verifying that the data in the EPCIS event has an invalid product identifier that is, a product identifier which is not valid or registered, the validation engine 302 determines that the EPCIS event comprises error. In this regard, the data in the EPCIS payload of the EPCIS event along with the error 502D which corresponds to ‘Invalid product identifier’ is rendered on the user interface 500D as illustrated in FIG. 5D.

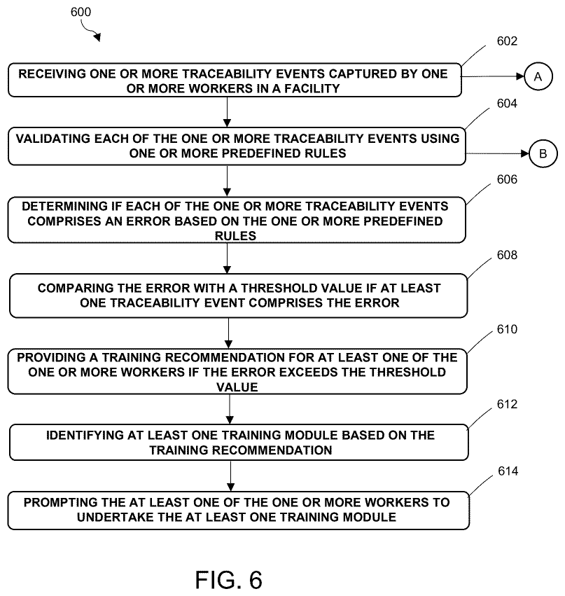

FIG. 6 illustrates a flowchart showing a method described in accordance with one or more example embodiments described herein. In this regard, FIG. 6 illustrates functions that may be performed by the training recommendation system 300. In some embodiments, the example method 600 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 600. At step 602 of the exemplary flowchart 600, the training recommendation system 300 comprises means such as, the validation engine 302 to receive one or more traceability events captured by one or more workers in a facility. In this regard, the one or more traceability events relate to one or more products that are handled in the facility. Then, at step 604 of the exemplary flowchart 600, the training recommendation system 300 comprises means such as, the validation engine 302 to validate each of the one or more traceability events using one or more predefined rules. Further, at step 606 of the exemplary flowchart 600, the training recommendation system 300 comprises means such as, the validation engine 302 to determine if each of the one or more traceability events comprises an error based on the one or more predefined rules. Furthermore, at step 608 of the exemplary flowchart 600, the training recommendation system 300 comprises means such as, the validation engine 302 to compare the error with a threshold value if at least one traceability event comprises the error. Also, at step 610 of the exemplary flowchart 600, the training recommendation system 300 comprises means such as, the training recommender 304 to provide a training recommendation for at least one of the one or more workers if the error exceeds the threshold value. Then, at step 612 of the exemplary flowchart 600, the training recommendation system 300 comprises means such as, the training recommender 304 to identify at least one training module based on the training recommendation. Additionally, at step 614 of the exemplary flowchart 600, the training recommendation system 300 comprises means such as, the training recommender 304 to prompt the at least one of the one or more workers to undertake the at least one training module.

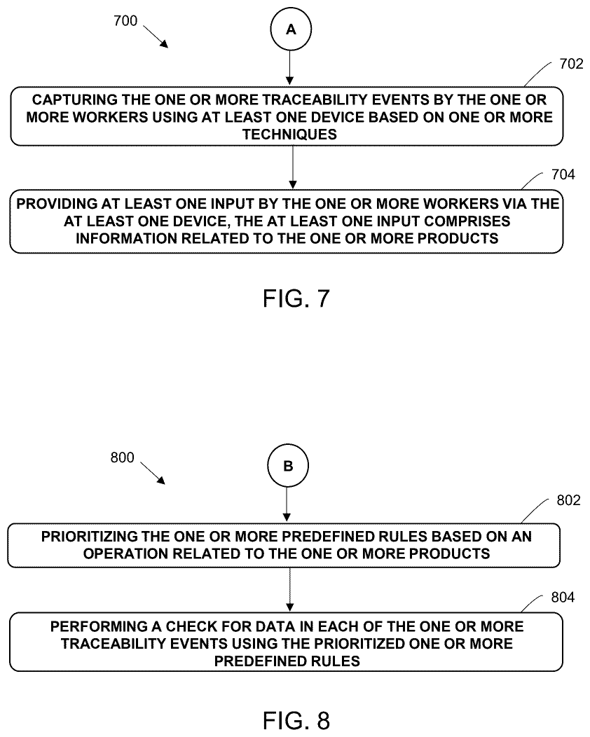

FIG. 7 illustrates a flowchart showing a method described in accordance with one or more example embodiments described herein. In this regard, FIG. 7 illustrates functions that may be performed by the training recommendation system 300. In some embodiments, the example method 700 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 700. At step 702 of the exemplary flowchart 700, the training recommendation system 300 comprises means such as, the validation engine 302 to receive the one or more traceability events captured by the one or more workers using at least one device based on one or more techniques. In this regard, the one or more techniques may comprise barcode scanning, Radio Frequency Identification (RFID) scanning, Enterprise Resource Planning (ERP) systems, and middleware integrations. Further, at step 704 of the exemplary flowchart 700, the training recommendation system 300 comprises means such as, the validation engine 302 to provide at least one input by the one or more workers via the at least one device. In this regard, the at least one input comprises information related to the one or more products.

FIG. 8 illustrates a flowchart showing a method described in accordance with one or more example embodiments described herein. In this regard, FIG. 8 illustrates functions that may be performed by the training recommendation system 300. In some embodiments, the example method 800 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 800. At step 802 of the exemplary flowchart 800, the training recommendation system 300 comprises means such as, the validation engine 302 to prioritize the one or more predefined rules based on an operation related to the one or more products. Further, at step 804 of the exemplary flowchart 800, the training recommendation system 300 comprises means such as, the validation engine 302 to perform a check for data in each of the one or more traceability events using the prioritized one or more predefined rules.

The foregoing embodiments are provided merely as illustrative examples and are not intended to require or imply that the steps of the various embodiments must be performed in the order presented. As will be appreciated by one of skill in the art the order of steps in the foregoing embodiments can be performed in any order. Words such as “thereafter,” “then,” “next,” etc. are not intended to limit the order of the steps; these words are simply used to guide the reader through the description of the methods. Further, any reference to claim elements in the singular, for example, using the articles “a,”“an” or “the” is not to be construed as limiting the element to the singular.

It is to be appreciated that ‘one or more’ includes a function being performed by one element, a function being performed by more than one element, e.g., in a distributed fashion, several functions being performed by one element, several functions being performed by several elements, or any combination of the above.

Moreover, it will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

The hardware used to implement the various illustrative logics, logical blocks, modules, and circuits described in connection with the aspects disclosed herein can include a general purpose processor, a digital signal processor (DSP), a special-purpose processor such as an application specific integrated circuit (ASIC) or a field programmable gate array (FPGA), a programmable logic device, discrete gate or transistor logic, discrete hardware components, or any combination thereof designed to perform the functions described herein. A general-purpose processor can be a microprocessor, but, in the alternative, the processor can be any processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Alternatively, or in addition, some steps or methods can be performed by circuitry that is specific to a given function.

In one or more example embodiments, the functions described herein can be implemented by special-purpose hardware or a combination of hardware programmed by firmware or other software. In implementations relying on firmware or other software, the functions can be performed as a result of execution of one or more instructions stored on one or more non-transitory computer-readable media and/or one or more non-transitory processor-readable media. These instructions can be embodied by one or more processor-executable software modules that reside on the one or more non-transitory computer-readable or processor-readable storage media. Non-transitory computer-readable or processor-readable storage media can in this regard comprise any storage media that can be accessed by a computer or a processor. By way of example but not limitation, such non-transitory computer-readable or processor-readable media can include random access memory (RAM), read-only memory (ROM), electrically erasable programmable read-only memory (EEPROM), FLASH memory, disk storage, magnetic storage devices, or the like. Disk storage, as used herein, includes compact disc (CD), laser disc, optical disc, digital versatile disc (DVD), floppy disk, and Blu-ray disc™, or other storage devices that store data magnetically or optically with lasers. Combinations of the above types of media are also included within the scope of the terms non-transitory computer-readable and processor-readable media. Additionally, any combination of instructions stored on the one or more non-transitory processor-readable or computer-readable media can be referred to herein as a computer program product.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components can be used in conjunction with the supply management system. Therefore, it is to be understood that the inventions are not to be limited to the specific embodiments disclosed and that modifications and other embodiments are intended to be included within the scope of the appended claims. Moreover, the steps in the method described above can not necessarily occur in the order depicted in the accompanying diagrams, and in some cases one or more of the steps depicted can occur substantially simultaneously, or additional steps can be involved. Although specific terms are employed herein, they are used in a generic and descriptive sense only and not for purposes of limitation. It is intended that the specification and examples be considered as exemplary only, with a true scope and spirit of the disclosure being indicated by the following claims.

1. A method for training workforce in a facility, the method comprising:
receiving one or more traceability events captured by one or more workers in the facility, wherein the one or more traceability events are related to one or more products that are handled in the facility;
validating each of the one or more traceability events using one or more predefined rules;
determining if each of the one or more traceability events comprises an error based on the one or more predefined rules;
comparing the error with a threshold value if at least one traceability event comprises the error;
providing a training recommendation for at least one of the one or more workers if the error exceeds the threshold value;
identifying at least one training module based on the training recommendation; and
prompting the at least one of the one or more workers to undertake the at least one training module.

2. The method of claim 1, wherein receiving the one or more traceability events comprises:
capturing the one or more traceability events by the one or more workers using at least one device based on one or more techniques, wherein the one or more techniques comprise barcode scanning, Radio Frequency Identification (RFID) scanning, Enterprise Resource Planning (ERP) systems, and middleware integrations; and
providing at least one input by the one or more workers via the at least one device, wherein the at least one input comprises information related to the one or more products.

3. The method of claim 1, wherein validating each of the one or more traceability events comprises:
prioritizing the one or more predefined rules based on an operation related to the one or more products; and
performing a check for data in each of the one or more traceability events using the prioritized one or more predefined rules.

4. The method of claim 1, further comprising:
assigning a category for the error based on an operation related to the one or more products in response to determining if each of the one or more traceability events comprises the error.

5. The method of claim 1, further comprising:
rendering, on a user interface, the training recommendation along with the error if the at least one traceability event comprises the error.

6. The method of claim 1, further comprising:
generating one or more corrective actions to address the error in response to determining that the at least one traceability event comprises the error.

7. The method of claim 1, further comprising:
providing one or more notifications to the at least one of the one or more workers in response to determining that the at least one traceability event comprises the error, wherein the one or more notifications comprise at least one of an alarm and an alert.

8. A system for training workforce in a facility, the system comprising:
a processor;
a memory communicatively coupled to the processor, wherein the memory comprises one or more instructions which when executed by the processor, cause the processor to:
receive one or more traceability events captured by one or more workers in the facility, wherein the one or more traceability events are related to one or more products that are handled in the facility;
validate each of the one or more traceability events using one or more predefined rules;
determine if each of the one or more traceability events comprises an error based on the one or more predefined rules;
compare the error with a threshold value if at least one traceability event comprises the error;
provide a training recommendation for at least one of the one or more workers if the error exceeds the threshold value;
identify at least one training module based on the training recommendation; and
prompt the at least one of the one or more workers to undertake the at least one training module.

9. The system of claim 8, wherein the processor is further configured to:
capture the one or more traceability events by the one or more workers using at least one device based on one or more techniques, wherein the one or more techniques comprise barcode scanning, Radio Frequency Identification (RFID) scanning, Enterprise Resource Planning (ERP) systems, and middleware integrations; and
provide at least one input by the one or more workers via the at least one device, wherein the at least one input comprises information related to the one or more products.

10. The system of claim 8, wherein the processor is further configured to:
prioritize the one or more predefined rules based on an operation related to the one or more products; and
perform a check for data in each of the one or more traceability events using the prioritized one or more predefined rules.

11. The system of claim 8, wherein the processor is further configured to:
assign a category for the error based on an operation related to the one or more products in response to determining if each of the one or more traceability events comprises the error.

12. The system of claim 8, wherein the processor is further configured to:
render, on a user interface, the training recommendation along with the error if the at least one traceability event comprises the error.

13. The system of claim 8, wherein the processor is further configured to:
generate one or more corrective actions to address the error in response to determining that the at least one traceability event comprises the error.

14. The system of claim 8, wherein the processor is further configured to:
provide one or more notifications to the at least one of the one or more workers in response to determining that the at least one traceability event comprises the error, wherein the one or more notifications comprise at least one of an alarm and an alert.

15. A non-transitory, computer-readable storage medium having stored thereon executable instructions that, when executed by one or more processors, cause the one or more processors to:
receive one or more traceability events captured by one or more workers in a facility, wherein the one or more traceability events are related to one or more products that are handled in the facility;
validate each of the one or more traceability events using one or more predefined rules;
determine if each of the one or more traceability events comprises an error based on the one or more predefined rules;
compare the error with a threshold value if at least one traceability event comprises the error;
provide a training recommendation for at least one of the one or more workers if the error exceeds the threshold value;
identify at least one training module based on the training recommendation; and
prompt the at least one of the one or more workers to undertake the at least one training module.

16. The non-transitory, computer-readable storage medium of claim 15, wherein the one or more processors is further configured to:
capture the one or more traceability events by the one or more workers using at least one device based on one or more techniques, wherein the one or more techniques comprise barcode scanning, Radio Frequency Identification (RFID) scanning, Enterprise Resource Planning (ERP) systems, and middleware integrations; and
provide at least one input by the one or more workers via the at least one device, wherein the at least one input comprises information related to the one or more products.

17. The non-transitory, computer-readable storage medium of claim 15, wherein the one or more processors is further configured to:
prioritize the one or more predefined rules based on an operation related to the one or more products; and
perform a check for data in each of the one or more traceability events using the prioritized one or more predefined rules.

18. The non-transitory, computer-readable storage medium of claim 15, wherein the one or more processors is further configured to:
assign a category for the error based on an operation related to the one or more products in response to determining if each of the one or more traceability events comprises the error.

19. The non-transitory, computer-readable storage medium of claim 15, wherein the one or more processors is further configured to:
render, on a user interface, the training recommendation along with the error if the at least one traceability event comprises the error.

20. The non-transitory, computer-readable storage medium of claim 15, wherein the one or more processors is further configured to:
generate one or more corrective actions to address the error in response to determining that the at least one traceability event comprises the error.
